(19) United States
(12) Patent Application Publication
(10) Pub. No.: US 2016/0274430 A1
(43) Pub. Date: Sep. 22, 2016

(54) LCD Panel and Via Hole Used for Electrical ConnectionThereof

(71) Applicant: SHENZHEN CHINA STAR OPTOELECTRONICS TECHNOLOGY CO. LTD., Shenzhen City, Guangdong (CN)

(72) Inventor: Yanxi YE, Shenzhen, Guangdong (CN)

(73) Assignee: Shenzhen China Star Optoelectronics Technology Co. Ltd., Shenzhen, Guangdong (CN)

(21) Appl. No.: 14/407,449

(22) PCT Filed: Nov. 17, 2014
(86) PCT No.: PCT/CN2014/091256

§ 371 Date: Dec. 11, 2014

(30) Foreign Application Priority Data
Nov. 10, 2014 (CN) 201410627889.6

(51) Int. Cl. G02F 1/1362; G02F 1/1333

(52) U.S. Cl. CPC G02F 1/136227; G02F 1/133345

(57) ABSTRACT

The present invention discloses a liquid crystal display panel and a via hole used for electrical connection. The via hole is provided on an insulating substrate with a first metal layer and a second metal layer provided on an upper surface and a lower surface of the insulating substrate. The inner wall of the via hole has a concave-convex structure, and a metal material adheres to the concave-convex structure of the via hole when sputtering the first metal layer, to realize the electrical connection between the first metal layer and the second metal layer. Through the above way, the present invention can increase the electrical connection area between the upper and lower metal layers, which reduces the resistance and power consumption for electrical signal transmission and avoids the delay of the electrical signal transmission.

### BACKGROUND OF THE INVENTION

1. Field of the Invention

The invention relates to technical field of liquid crystal display (LCD), and specifically relates to technical field of via hole design, in particular to a LCD panel and the via hole used for electrical connection thereof.

2. The Related Arts

As an important and indispensable designing structure to liquid crystal display panels, via can connect electrically the upper and lower two metal layer, and therefore the signal transmission in LCD can be realized by via hole. Currently, the industry generally uses sputtering method to form upper metal layer on the insulating layer with via hole. The material of upper metal layer gradually diffuse from the edge to inner wall of the via hole, and adhere to the inner wall to form the connection with lower metal layer. However, the current via size is small and smooth, thereby leading the inner wall to become a smooth structure. The area of the metal layer for connection is small, therefore the area using for connection between the upper and lower metal layer is small, leading to large contact resistance for electrical connection. Not only the power consumption is increased, but also the problems of signal delay are easy to occur.

### SUMMARY OF THE INVENTION

Accordingly, the technical problem to be solved by the present invention (the embodiment of the invention) is to provide a liquid crystal display panel and via hole used for electrical connection thereof, which can increase the electrical connection area between the upper and lower metal layers, reduce the resistance and power consumption for electrical signal transmission and avoid the delay of the electrical signal transmission.

In order to solve the above problems, an aspect of the present invention is to provide via hole used for electrical connection, wherein the via hole is provided on an insulating substrate with a first metal layer and a second metal layer provided on an upper surface and a lower surface of the insulating substrate, wherein the inner wall of the via hole has a concave-convex structure, and a metal material adheres to the concave-convex structure of the via hole when sputtering the first metal layer, to realize the electrical connection between the first metal layer and the second metal layer; wherein, the via hole on the edges of the upper and/or lower surface of the insulating substrate is a concave-convex curve along a sight direction perpendicular to the upper surface and the lower surface of the insulating substrate, and the concave-convex structure is a centrosymmetric pattern.

Wherein, the contour lines of the concave-convex curve and the concave-convex structure are the same along the sight direction.

Wherein, the shapes of the concave-convex structure is selected from the sharp jagged shape and rounded petal shape along the sight direction perpendicular to the upper surface and the lower surface of the insulating substrate.

In order to solve the above problems, another aspect of the present invention is to provide via hole used for electrical connection, wherein the via hole is provided on an insulating substrate with a first metal layer and a second metal layer provided on an upper surface and a lower surface of the insulating substrate, wherein, the inner wall of the via hole has a concave-convex structure, and a metal material adheres to the concave-convex structure of the via hole when sputtering the first metal layer, to realize the electrical connection between the first metal layer and the second metal layer.

Wherein, the via hole on the edges of the upper and/or lower surface of the insulating substrate is a concave-convex curve along a sight direction perpendicular to the upper surface and the lower surface of the insulating substrate.

Wherein, the contour lines of the concave-convex curve and the concave-convex structure are the same along the sight direction.

Wherein, the via hole on the edges of the upper and/or lower surface of the insulating substrate is a straight line or a smooth curved shape along the sight direction perpendicular to the upper surface and the lower surface of the insulating substrate.

Wherein, the concave-convex structure is the centrosymmetric pattern along a sight direction perpendicular to the upper surface and the lower surface of the insulating substrate.

Wherein, the shapes of the concave-convex structure include a sharp jagged shape and a rounded petal shape along the sight direction perpendicular to the upper surface and the lower surface of the insulating substrate.

In order to solve the above problems, a further aspect of the present invention is to provide a liquid crystal display panel, wherein an insulating substrate of the liquid crystal display panel has at least one via hole, a first metal layer and a second metal layer are provided on an upper surface and a lower surface of the insulating substrate, wherein the inner wall of the via hole has a concave-convex structure, and a metal material adheres to the concave-convex structure of the via hole when sputtering the first metal layer, to realize the electrical connection between the first metal layer and the second metal layer.

Wherein, the insulating substrate is an integrally formed structure.

Wherein, the insulating substrate comprises a first insulating layer, a second insulating layer, and a third metal layer between the first insulating layer and the second insulating layer, the third metal layer is insulated from the first metal layer and the second metal layer when the first metal layer and second metal layer are electrically connected.

Wherein, the insulating substrate is provided on an array substrate of the liquid crystal display panel.

Wherein, the via hole on the edges of the upper and/or lower surface of the insulating substrate is a concave-convex curve along the sight direction perpendicular to the upper surface and the lower surface of the insulating substrate.

Wherein, the contour lines of the concave-convex curve and the concave-convex structure are the same along the sight direction.

Wherein, the via hole on the edges of the upper and/or lower surface of the insulating substrate is a straight line or a smooth curved shape along the sight direction perpendicular to the upper surface and the lower surface of the insulating substrate.

Wherein, the concave-convex structure is a centrosymmetric pattern along the sight direction perpendicular to the upper surface and the lower surface of the insulating substrate.

Wherein, the shapes of the concave-convex structure include a sharp jagged shape and a rounded petal shape along the sight direction perpendicular to the upper surface and the lower surface of the insulating substrate.

With the adoption of the above technical scheme, the beneficial effects of the embodiment of the invention are as follows.

The embodiment of the present invention is to design a concave-convex structure on the inner wall of the via hole provided on the insulating substrate. Comparing with the prior art, the dimension of the second metal layer sputtered on the concave-convex structure are increased, and therefore the dimension for the electrical connection between the first and second metal layer is increased to reduce the resistance and power consumption for electrical signal transmission and avoid delay of the electrical signal transmission.

### BRIEF DESCRIPTION OF THE DRAWINGS

FIG. 1 is a top view of the via hole structure according to the first embodiment of the present invention;

FIG. 2 is a schematic diagram of the insulating substrate shown in FIG. 1 with the first metal layer and second metal layer according to an exemplary embodiment of the present invention;

FIG. 3 is a top view of the via hole structure according to the second embodiment of the present invention;

FIG. 4 is a top view of the via hole structure according to the third embodiment of the present invention;

FIG. 5 is a top view of the via hole structure according to the fourth embodiment of the present invention; and

FIG. 6 is a cross-sectional view of the LCD structure with the insulating substrate shown in FIG. 1.

### DETAILED DESCRIPTION OF THE PREFERRED EMBODIMENTS

In the following embodiments of the invention in conjunction with the accompanying drawings, embodiments of the present invention, the technical solutions clearly and completely described, obviously, the described embodiments are only part of the embodiments of the present invention, but not all of the implementation of the case. Based on the embodiment of the present invention, persons of ordinary skill in the art without creative efforts obtained under the premise that all other embodiments, all belong to the protection scope of the present invention.

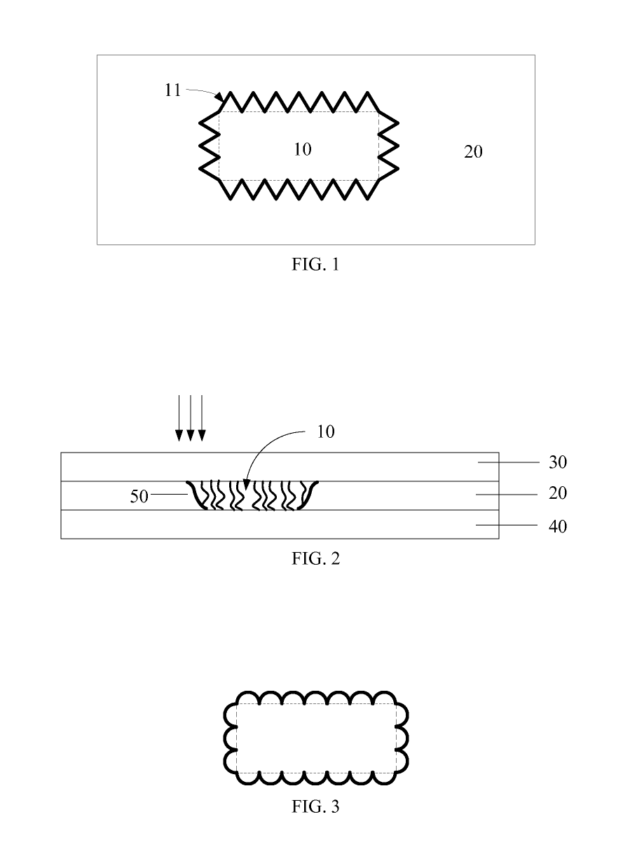

FIG. 1 is a top view of the via hole structure in the first embodiment of the present invention. As shown in FIG. 1, the via hole 10 in present embodiment is provided on the insulating substrate 20, the upper and lower surface of the have the first metal layer 30 and the second metal layer 40 as shown in FIG. 2, wherein the diameter of the via hole 10 is gradually reduced along the line of sight direction from the first metal layer 30 to the second metal layer 40, and the inner wall of the via hole 10 has the concave-convex structure 11. During the manufacturing process of the first metal layer 30 by sputtering, the metal material adhere the concave-convex structure 11 on the inner wall of the via hole 10, and therefore a metal layer can be formed. The metal layer is a portion of the first metal layer 30, and therefore the electrical connection between the first metal layer 30 and the second metal layer 40 can be realized by using the metal layer to connect the first metal layer 30 and the second metal layer 40.

In the present embodiment, the concave-convex structure 11 on the inner wall of the via hole 10 is substantially a wrinkle structure, and the wrinkle structure is provided along the gravity direction, and therefore the metal layer formed on the concave-convex structure 11 by sputtering the also has the wrinkle structure provided along the gravity direction (the line of sight direction).

Compared to the present art about the via hole (as shown in FIG. 1 as a dotted line), the design of the concave-convex structure 11 in present embodiment increase the dimension of the inner wall of the via hole 10, and hence the dimension of the metal layer (the first metal layer 30) sputtered on the concave-convex structure 11 is increased, and furthermore can increase the electrical connection area between the first metal layer 30 and the second metal layer 40 to reduce resistance and the power consumption for electrical signal transmission, and hence the signal delay can be avoided.

Referring again to FIG. 1, along the line of sight direction perpendicular to the upper and lower surface as shown in FIG. 2 (direction shown by the arrow), preferred via hole 10 the concave-convex structure is centrosymmetric pattern. The edge of via hole 10 on the upper surface of the insulating substrate 20 assume a concave-convex curved shape, and the contour line of this shape is the same as the contour line of the shape assumed by the concave-convex structure 11.

In a similar way, the edge of via hole 10 on the lower surface of the insulating substrate 20 assume a concave-convex curved shape, and the contour line of this shape is the same as the contour line of the shape assumed by the concave-convex structure 11.

In other embodiments, along the line of sight direction as shown in FIG. 2, the via hole 10 on the edges of the upper and/or lower surface of the insulating substrate 20 is a straight line or a smooth curved shape, and the contour line of this shape is not the same as the contour line of the shape assumed by the concave-convex structure 11, thereby the via hole 10 comprise of the rectangular and cylindrical region between the top of the concave-convex structure 11 and the upper surface of the insulating substrate 20.

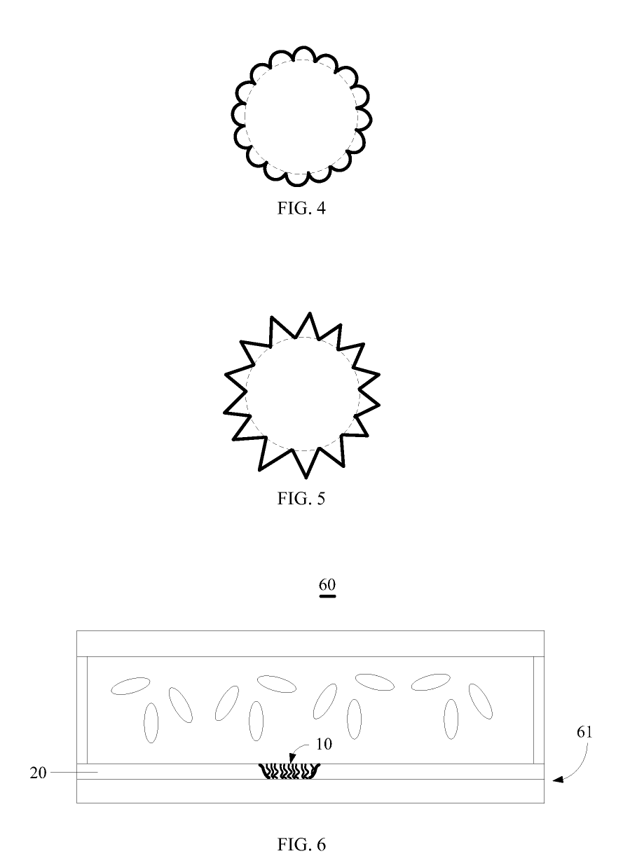

In other embodiments, the concave-convex structure 11 on the inner wall of the via hole 10 can assume other types of shapes along the line of sight direction as shown in FIG. 2, including the rounded petal shape with round angle as shown in FIG. 3, the circular petal shape with round angle as shown in FIG. 4, and the circular jagged shape as shown in FIG. 5, which are not limited to the square jagged shape as shown in FIG. 1.

The rounded petal shape means that the via hole 10 comprises the region inside the rectangle as shown in FIG. 3 as a dotted line, and the several semicircular and semielliptical regions outside the aforementioned rectangle. The circular jagged shape means that the via hole 10 comprises the inside region inside the circle as shown in FIG. 5 as a dotted line, and several jagged regions outside the aforementioned circle.

In present embodiment, the first metal layer 30 and the second metal layer 40 can be using for the data line and source of the pixel electrode separately, within IPS (In-Plane Switching) display panel or FFS (Fringe Field Switching) display panel or any other display panel using via hole to realize signal transmission with electrical connection.

Besides, the insulating substrate 20 is an integrally formed structure. such as the insulating layer between the data line and pixel electrode within IPS display panel; can also be the multilayer structure, such as the insulating substrate 20 comprises of the first insulating layer, the second insulating layer, and third metal layer between the first and second insulating layer, and wherein the third metal layer is common electrode layer of the FFS display panel and insulated from the first metal layer 30 and second metal layer 40 when the first metal layer 30 and second metal layer 40 are electrical connected.

The present embodiment is still providing a LCD panel 60 with the insulating substrate 20 as shown in FIG. 6, wherein the preferred insulating substrate 20 with the via hole 10 is arranged on the LCD array substrate 61 and thereby the technical effect of the via hole 10 in aforementioned embodiments is achieved.

Finally, it must be noted again that the above described embodiments of the invention only, and not limit the patent scope of the present invention, therefore, the use of all the contents of the accompanying drawings and the description of the present invention is made to equivalent structures or equivalent conversion process, e.g., between the embodiments Example technology mutually binding characteristics, directly or indirectly related to the use of technology in other fields, are included within the scope of patent empathy protection of the invention.

What is claimed is:

1. A via hole used for electrical connection, wherein the via hole is provided on an insulating substrate with a first metal layer and a second metal layer provided on an upper surface and a lower surface of the insulating substrate, wherein the inner wall of the via hole has a concave-convex structure, and a metal material adheres to the concave-convex structure of the via hole when sputtering the first metal layer, to realize the electrical connection between the first metal layer and the second metal layer; wherein, the via hole on the edges of the upper and/or lower surface of the insulating substrate is a concave-convex curve along a sight direction perpendicular to the upper surface and the lower surface of the insulating substrate, and the concave-convex structure is a centrosymmetric pattern.

2. The via hole as claimed in claim 1, wherein the contour lines of the concave-convex curve and the concave-convex structure are the same along the sight direction.

3. The via hole as claimed in claim 1, wherein the shapes of the concave-convex structure is selected from the sharp jagged shape and rounded petal shape along the sight direction perpendicular to the upper surface and the lower surface of the insulating substrate.

4. A via hole used for electrical connection, wherein the via hole is provided on an insulating substrate with a first metal layer and a second metal layer provided on an upper surface and a lower surface of the insulating substrate, wherein, the inner wall of the via hole has a concave-convex structure, and a metal material adheres to the concave-convex structure of the via hole when sputtering the first metal layer, to realize the electrical connection between the first metal layer and the second metal layer.

5. The via hole as claimed in claim 4, wherein the via hole on the edges of the upper and/or lower surface of the insulating substrate is a concave-convex curve along a sight direction perpendicular to the upper surface and the lower surface of the insulating substrate.

6. The via hole as claimed in claim 5, wherein the contour lines of the concave-convex curve and the concave-convex structure are the same along the sight direction.

7. The via hole as claimed in claim 4, wherein the via hole on the edges of the upper and/or lower surface of the insulating substrate is a straight line or a smooth curved shape along the sight direction perpendicular to the upper surface and the lower surface of the insulating substrate.

8. The via hole as claimed in claim 4, wherein the concave-convex structure is the centrosymmetric pattern along a sight direction perpendicular to the upper surface and the lower surface of the insulating substrate.

9. The via hole as claimed in claim 8, wherein the shapes of the concave-convex structure include a sharp jagged shape and a rounded petal shape along the sight direction perpendicular to the upper surface and the lower surface of the insulating substrate.

10. A liquid crystal display panel, wherein an insulating substrate of the liquid crystal display panel has at least one via hole, a first metal layer and a second metal layer are provided on an upper surface and a lower surface of the insulating substrate, wherein the inner wall of the via hole has a concave-convex structure, and a metal material adheres to the concave-convex structure of the via hole when sputtering the first metal layer, to realize the electrical connection between the first metal layer and the second metal layer.

11. The liquid crystal display panel as claimed in claim 10, wherein the insulating substrate is an integrally formed structure.

12. The liquid crystal display panel as claimed in claim 10, wherein the insulating substrate comprises a first insulating layer, a second insulating layer, and a third metal layer between the first insulating layer and the second insulating layer, the third metal layer is insulated from the first metal layer and the second metal layer when the first metal layer and second metal layer are electrically connected.

13. The liquid crystal display panel as claimed in claim 10, wherein the insulating substrate is provided on an array substrate of the liquid crystal display panel.

14. The liquid crystal display panel as claimed in claim 10, wherein the via hole on the edges of the upper and/or lower surface of the insulating substrate is a concave-convex curve along the sight direction perpendicular to the upper surface and the lower surface of the insulating substrate.

15. The liquid crystal display panel as claimed in claim 13, wherein the contour lines of the concave-convex curve and the concave-convex structure are the same along the sight direction.

16. The liquid crystal display panel as claimed in claim 10, wherein the via hole on the edges of the upper and/or lower surface of the insulating substrate is a straight line or a smooth curved shape along the sight direction perpendicular to the upper surface and the lower surface of the insulating substrate.

17. The liquid crystal display panel as claimed in claim 10, wherein the concave-convex structure is a centrosymmetric pattern along the sight direction perpendicular to the upper surface and the lower surface of the insulating substrate.

18. The liquid crystal display panel as claimed in claim 17, wherein the shapes of the concave-convex structure include a sharp jagged shape and a rounded petal shape along the sight direction perpendicular to the upper surface and the lower surface of the insulating substrate.
